(19) United States
(12) Patent Application Publication
(10) Pub. No.: US 2008/0198796 A1
(43) Pub. Date: Aug. 21, 2008

(54) Method and Apparatus for Enhancing System Efficiency in a Wireless Communications System

(76) Inventor: Yu-Chih Jen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/031,724

(22) Filed: Feb. 15, 2008

Related U.S. Application Data
(60) Provisional application No. 60/890,192, filed on Feb. 16, 2007.

(51) Int. Cl. H04Q 7/00

(52) U.S. Cl. 370/328

(57) ABSTRACT

A method for enhancing system efficiency of a user equipment, called UE hereinafter, in a wireless communications system includes operating in a Cell Forward Link Access Channel, called CELL_FACH hereinafter, state with a common High Speed Downlink Shared Channel radio network transaction identifier, called common H-RNTI hereinafter, and a dedicated H-RNTI, and providing a confirmation signal with utilizing the dedicated H-RNTI for a network when the network sends transmissions of Dedicated Control Channel, called DCCH hereafter, and Dedicated Traffic Channel, called DTCH hereinafter, with using the common H-RNTI to the UE.

### CROSS REFERENCE TO RELATED APPLICATIONS

This application claims the benefit of U.S. Provisional Application No. 60/890,192, filed on Feb. 16, 2007 and entitled “Handling transition of Enhanced CELL_FACH state HSDPA and Improvement of CELL_FACH operation,” the contents of which are incorporated herein by reference.

### BACKGROUND OF THE INVENTION

1. Field of the Invention

The present invention relates to a method and apparatus for enhancing system efficiency in a wireless communications system, and more particularly, to a method and apparatus for decreasing overhead and transmission time, and enhancing system efficiency.

2. Description of the Prior Art

The third generation (3G ) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

In addition, RRC states contain an idle mode and an RRC connected mode, and the RRC connected mode includes CELL_PCH, URA_PCH, CELL_FACH and CELL_DCH states.

In CELL_FACH, the transmission route of downlink data and control signaling is from CTCH (Common Traffic Channel) and CCCH (Common Control Channel) and/or DTCH (Dedicated Traffic Channel) and DCCH (Dedicated Control Channel), provided by RLC (Radio Link Control) layer, via FACH (Forward Link Access Channel), provided by MAC, to S-CCPCH (Secondary-Common Control Physical Channel), provided by PHY (Physical) layer. Except CELL_DCH, the prior art also adds HSDPA-like functions into CELL_FACH, CELL_PCH, or URA_PCH state, to enhance efficiency of CELL_FACH, CELL_PCH, or URA_PCH state. Therefore, UE in CELL_FACH can use HS-DSCH on specified channels (BCCH, CCCH, DCCH and DTCH), so as to improve peak data rate, signaling delay, state transition delay, download times and flexible cell capacity in CELL_FACH. In such a situation, FACH and S-CCPCH in downlink transmission are replaced by HS-DSCH and HS-PDSCH.

There are two schemes to trigger HSDPA in CELL_FACH in the prior art. One is system information broadcast, which enables HS-DSCH reception in CELL_FACH state via HS-SCCH and HS-DSCH configuration and a common HS-DSCH radio network transaction identifier (common H-RNTI), and uses MAC-c PDU (Protocol Data Unit) as MAC-hs SDU (Service Data Unit). The other is to use a dedicated H-RNTI for HS-DSCH reception in CELL_FACH state, and use MAC-d or MAC-c PDU as MAC-hs SDU. However, the above schemes induce different problems.

First, it's quite reasonable to use a common H-RNTI and MAC-c PDU as MAC-hs SDU for CCCH/CTCH transmission since multiple UEs' data can be multiplexed in a single HS-DSCH TTI and Node B doesn't need to maintain UE information for CELL_FACH state even though sometimes it's preferable to have several common H-RNTIs to make UEs into a service/class group. However, for DCCH/DTCH transmission, there may be several disadvantages to use MAC-c PDU as MAC-hs SDU and/or common H-RNTI.

For example, since Node B has no UE context and cannot map CQI and identify MAC-c PDU for each UE, it's difficult for UEs to provide any kind of feedback with cell common H-RNTI.

Besides, downlink SU-MIMO (Single User Multi-input Multi-output) and MU-MIMO (Multi-User Multi-input Multi-output) and uplink SU-MIMO has been proposed to increase data rate and performance for HSDPA and HSUPA respectively. However, the MIMO is intended to support UEs in CELL_DCH state. There will be issues to continue or start a session/service of transmissions when a UE in CELL_DCH state move to CELL_FACH state or a UE originally is in CELL_FACH state.

Moreover, a UE with specific/dedicated H-RNTI in enhanced CELL_FACH state, it's critical in many senses (e.g. radio resource) to send measurement of HS-DSCH with specific H-RNTI and FACH to network entity (e.g. Node B). Therefore, a method to save the transport block size and frequency of occurrence shall be considered. In addition, it's preferred that the method can work well also for the case common H-RNTI is used. In other word, the method to form or trigger measurement report shall be independent to whether H-RNTI is dedicated or not.

Furthermore, for UEs in CELL_DCH state, the network can configure CPC (Continuous Packet Connectivity) to significantly increase the number of packet data users for a cell, reduce the uplink noise rise and improve the achievable download capacity for VoIP. CPC includes mechanisms of uplink DTX, uplink DRX, downlink DRX, and HS-SCCH less operation, for reducing UE power consumption. However, CPC was only be specified in CELL_DCH state for UEs.

### SUMMARY OF THE INVENTION

According to the present invention, a method for enhancing system efficiency of a user equipment, called UE hereinafter, in a wireless communications system comprises operating in a Cell Forward Link Access Channel, called CELL_FACH hereinafter, state with a common High Speed Downlink Shared Channel radio network transaction identifier, called common H-RNTI hereinafter, and a dedicated H-RNTI, and providing a confirmation signal with utilizing the dedicated H-RNTI for a network when the network sends transmissions of Dedicated Control Channel, called DCCH hereafter, and Dedicated Traffic Channel, called DTCH hereinafter, with using the common H-RNTI to the UE.

According to the present invention, a method for enhancing system efficiency of a user equipment, called UE hereinafter, in a wireless communications system comprises operating in a Cell Forward Link Access Channel, called CELL_FACH hereinafter, state with a common High Speed Downlink Shared Channel radio network transaction identifier, called common H-RNTI hereinafter, or a dedicated H-RNTI, and providing a confirmation signal with utilizing a cell RNTI, a network RNTI, or the dedicated H-RNTI for a network when the network sends transmissions of Dedicated Control Channel, called DCCH hereafter, and Dedicated Traffic Channel, called DTCH hereinafter, with using the common H-RNTI or the dedicated H-RNTI to the UE.

According to the present invention, method for enhancing system efficiency of a user equipment, called UE hereinafter, in a wireless communications system comprises operating in a Cell Forward Link Access Channel, called CELL_FACH hereinafter, state or entering the CELL_FACH state, and transmitting a measurement result or report to a network when a trigger condition is fulfilled.

According to the present invention, a method for enhancing system efficiency in a network of a wireless communications system comprises a user equipment, called UE hereinafter, operating in a Cell Dedicated Channel, called CELL_DCH hereinafter, state and having triggered a Multi-input Multi-output, called MIMO hereinafter, operation, and sending a control message to stop the MIMO operation of the UE when the UE moves to a Cell Forward Link Access Channel, called CELL_FACH hereinafter, state.

According to the present invention, a method for enhancing system efficiency of a user equipment, called UE hereinafter, in a wireless communications system comprises operating in a Cell Dedicated Channel, called CELL_DCH hereinafter, state and having triggered a Multi-input Multi-output, called MIMO hereinafter, operation; and stop the MIMO operation immediately or after certain time when the UE moves to a Cell Forward Link Access Channel, called CELL_FACH hereinafter, state.

According to the present invention, a method for enhancing system efficiency of a user equipment, called UE hereinafter, in a wireless communications system comprises operating in a Cell Dedicated Channel, called CELL_DCH hereinafter, state and having triggered a Multi-input Multi-output, called MIMO hereinafter, operation, and switching to MIMO configuration for a High Speed Downlink Shared Channel, called HS-DSCH hereinafter, immediately or after certain time when the UE moves to a Cell Forward Link Access Channel, called CELL_FACH hereinafter, state.

According to the present invention, a method for enhancing system efficiency of a user equipment, called UE hereinafter, in a wireless communications system comprises performing discontinuous reception on transmissions of Dedicated Control Channel, called DCCH hereafter, and Dedicated Traffic Channel, called DTCH hereinafter according to a discontinuous reception configuration when operating in a Cell Dedicated Channel, called CELL_DCH hereinafter, state with either a common High Speed Downlink Shared Channel radio network transaction identifier, called common H-RNTI hereinafter, or a dedicated H-RNTI.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises operating in a Cell Forward Link Access Channel, called CELL_FACH hereinafter, state with a common High Speed Downlink Shared Channel radio network transaction identifier, called common H-RNTI hereinafter, and a dedicated H-RNTI, and providing a confirmation signal with utilizing the dedicated H-RNTI for a network when the network sends transmissions of Dedicated Control Channel, called DCCH hereafter, and Dedicated Traffic Channel, called DTCH hereinafter, with using the common H-RNTI to the communications device.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises operating in a Cell Forward Link Access Channel, called CELL_FACH hereinafter, state with a common High Speed Downlink Shared Channel radio network transaction identifier, called common H-RNTI hereinafter, or a dedicated H-RNTI, and providing a confirmation signal with utilizing a cell RNTI, a network RNTI, or the dedicated H-RNTI for a network when the network sends transmissions of Dedicated Control Channel, called DCCH hereafter, and Dedicated Traffic Channel, called DTCH hereinafter, with using the common H-RNTI or the dedicated H-RNTI to the communications device.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises operating in a Cell Forward Link Access Channel, called CELL_FACH hereinafter, state or entering the CELL_FACH state, and transmitting a measurement result or report to a network when a trigger condition is fulfilled.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises a user equipment, called UE hereinafter, operating in a Cell Dedicated Channel, called CELL_DCH hereinafter, state and having triggered a Multi-input Multi-output, called MIMO hereinafter, operation, and sending a control message to stop the MIMO operation of the UE when the UE moves to a Cell Forward Link Access Channel, called CELL_FACH hereinafter, state.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises operating in a Cell Dedicated Channel, called CELL_DCH hereinafter, state and having triggered a Multi-input Multi-output, called MIMO hereinafter, operation, and stop the MIMO operation immediately or after certain time when the UE moves to a Cell Forward Link Access Channel, called CELL_FACH hereinafter, state.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises operating in a Cell Dedicated Channel, called CELL_DCH hereinafter, state and having triggered a Multi-input Multi-output, called MIMO hereinafter, operation, and switching to MIMO configuration for a High Speed Downlink Shared Channel, called HS-DSCH hereinafter, immediately or after certain time when the UE moves to a Cell Forward Link Access Channel, called CELL_FACH hereinafter, state.

According to the present invention, a communications device of a wireless communications system utilized for enhancing system efficiency comprises a control circuit for realizing functions of the communications device, a processor installed in the control circuit for executing a program code to operate the control circuit, and a memory coupled to the processor for storing the program code. The program code comprises performing discontinuous reception on transmissions of Dedicated Control Channel, called DCCH hereafter, and Dedicated Traffic Channel, called DTCH hereinafter according to a discontinuous reception configuration when operating in a Cell Dedicated Channel, called CELL_DCH hereinafter, state with either a common High Speed Downlink Shared Channel radio network transaction identifier, called common H-RNTI hereinafter, or a dedicated H-RNTI.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 to FIG. 9 are flowcharts of processes according to the embodiment of the present invention.

### DETAILED DESCRIPTION

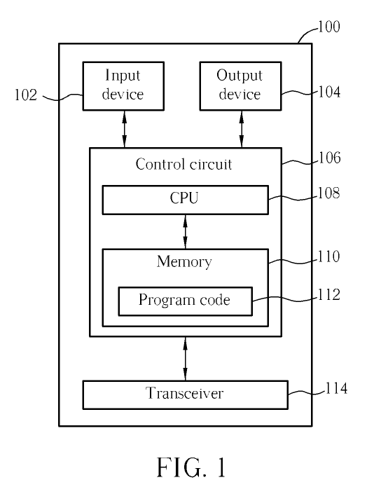

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G ) mobile communications system.

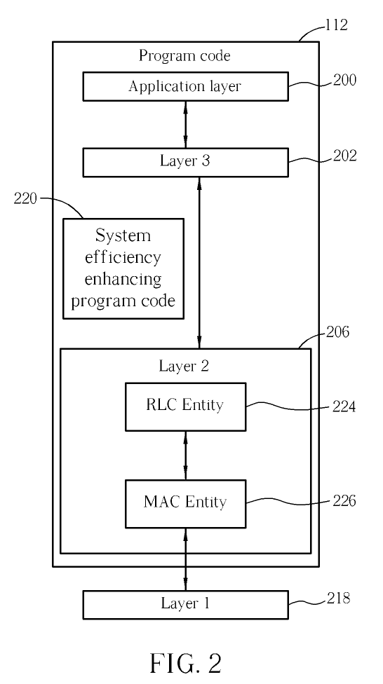

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 2 206 comprises two sub-layers: a radio link control (RLC) entity 224 and a media access control (MAC) entity 226. A primary function of the RLC entity 224 is providing different transmission quality processing, performing segmentation, reassembly, concatenation, padding, retransmission, sequence check, and duplication detection on transmitted data or control instructions based on different transmission quality requirements. The MAC entity 226 can match packets received from different logic channels of the RLC entity 224 to common, shared, or dedicated transport channels according to radio resource allocation commands of the Layer 3 (RRC layer) 202, for performing channel mapping, multiplexing, transport format selection, or random access control.

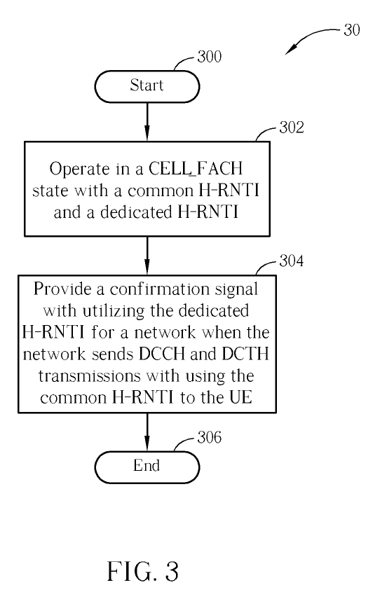

As mentioned above, the prior art also adds HSDPA-like functions into CELL_FACH to enhance efficiency of CELL_FACH state, so that UE in CELL_FACH can use HS-DSCH, to improve peak data rate, signaling delay, state transition delay, download times and flexible cell capacity in CELL_FACH. In such a situation, the embodiment of the present invention provides a system efficiency enhancing program code 220, to reduce signaling and enhance system efficiency. Please refer to FIG. 3, which illustrates a schematic diagram of a process 30 according to an embodiment of the present invention. The process 30 is utilized for enhancing system efficiency in a UE of a wireless communications system, and can be compiled into the system efficiency enhancing program code 220. The process 30 comprises the following steps:

Step 300: Start.

Step 302: Operate in a CELL_FACH state with a common H-RNTI and a dedicated H-RNTI.

Step 304: Provide a confirmation signal with utilizing the dedicated H-RNTI for a network when the network sends DCCH and DCTH transmissions with using the common H-RNTI to the UE.

Step 306: End.

According to the process 30, when a UE operates in CELL_FACH state with a common H-RNTI and a dedicated H-RNTI, if the network sends DCCH and DCTH transmissions with using the common H-RNTI to the UE, the UE can provide a confirmation signal with utilizing the dedicated H-RNTI for the network. In other words, the embodiment of the present invention uses the dedicated H-RNTI to provide feedback for the network, so as to report the receiving status.

In the prior art, since Node B has no UE context and cannot map CQI and identify MAC-c PDU for each UE, it's difficult for UEs to provide any kind of feedback with cell common H-RNTI. In compassion, in the embodiment of the present invention, when the network sends DCCH and DCTH transmissions with using the common H-RNTI to the UE, the UE can send the confirmation signal with utilizing the dedicated H-RNTI to the network.

Therefore, via the process 30, when the UE operates in CELL_FACH state with the common H-RNTI and the dedicated H-RNTI, if the network sends DCCH and DCTH transmissions with using the common H-RNTI to the UE, the UE can provide the confirmation signal with utilizing the dedicated H-RNTI for the network. As a result, the network can recognize the receiving status of the UE, so as to enhance system efficiency.

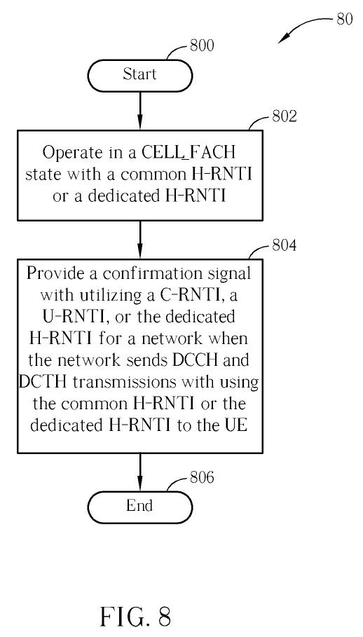

Please refer to FIG. 8, which illustrates a schematic diagram of a process 80 according to an embodiment of the present invention. The process 80 is utilized for enhancing system efficiency in a UE of a wireless communications system, and can be compiled into the system efficiency enhancing program code 220. The process 80 comprises the following steps:

Step 800: Start.

Step 802: Operate in a CELL_FACH state with a common H-RNTI or a dedicated H-RNTI.

Step 804: Provide a confirmation signal with utilizing a C-RNTI, a U-RNTI, or the dedicated H-RNTI for a network when the network sends DCCH and DCTH transmissions with using the common H-RNTI or the dedicated H-RNTI to the UE.

Step 806: End.

According to the process 80, when a UE operates in CELL_FACH state with a common H-RNTI or a dedicated H-RNTI, if the network sends DCCH and DCTH transmissions with using the common H-RNTI or the dedicated H-RNTI to the UE, the UE can provide a confirmation signal with utilizing a C-RNTI, a U-RNTI, or the dedicated H-RNT for the network. In other words, the embodiment of the present invention uses C-RNTI, U-RNTI, or the dedicated H-RNTI to provide feedback for the network, so as to report the receiving status.

In the prior art, since Node B has no UE context and cannot map CQI and identify MAC-c PDU for each UE, it's difficult for UEs to provide any kind of feedback with cell common H-RNTI. In compassion, in the embodiment of the present invention, when the network sends DCCH and DCTH transmissions with using the common H-RNTI or the dedicated H-RNTI to the UE, the UE can send the confirmation signal with utilizing C-RNTI, U-RNTI, or the dedicated H-RNTI to the network.

Therefore, via the process 80, when the UE operates in CELL_FACH state with the common H-RNTI or the dedicated H-RNTI, if the network sends DCCH and DCTH transmissions with using the common H-RNTI or the dedicated H-RNTI to the UE, the UE can provide the confirmation signal with utilizing C-RNTI, U-RNTI, or the dedicated H-RNTI for the network. As a result, the network can recognize the receiving status of the UE, so as to enhance system efficiency.

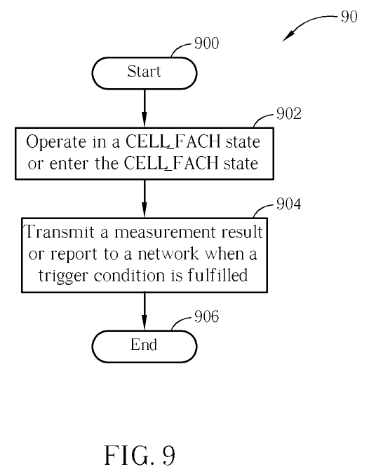

Please refer to FIG. 9, which illustrates a schematic diagram of a process 90 according to an embodiment of the present invention. The process 90 is utilized for enhancing system efficiency in a UE of a wireless communications system, and can be compiled into the system efficiency enhancing program code 220. The process 90 comprises the following steps:

Step 900: Start.

Step 902: Operate in a CELL_FACH state or enter the CELL_FACH state.

Step 904: Transmit a measurement result or report to a network when a trigger condition is fulfilled.

Step 906: End.

According to the process 90, when the UE operates in a CELL_FACH state or enters the CELL_FACH state, the UE can transmit a measurement result or report to a network when a trigger condition is fulfilled.

Preferably, when the trigger condition is fulfilled, the UE transmits the measurement result or report through random access procedure, or cell update procedure, or neighboring cell list update, or active cell update procedure. The measurement result or report can be a CELL_FACH, or High Speed Downlink Shared Channel, called HS-DSCH hereinafter, measurement, or downlink reference message, or buffer status measurement, or inter-frequency measurement, with complete information required. Meanwhile, if a measurement result or report of the same kind of measurement is triggered with fulfilled condition, the UE preferably considers whether the difference of measurement contents between measurement result sent previously and current measurement result to decided whether to send measurement report. Moreover, the UE preferably transmits the difference between the measurement result sent previously and current measurement result when retransmitting the measurement result or report.

Furthermore, the embodiment of the present invention can preferably trigger a less operation in CELL_FACH, and the less operation can be control channel less operation or operation with reduced or eliminated transmission of control information or operation with pruned-size control information transmission or operation with transmission of shared control information or operation without mandatory accompanying transmission of control information associated with corresponding data transmission.

Therefore, via the process 90, when the UE operates in CELL_FACH or enters the CELL_FACH state, the UE can transmit a measurement result or report to a network. As a result, the network can recognize the receiving status of the UE, so as to enhance system efficiency.

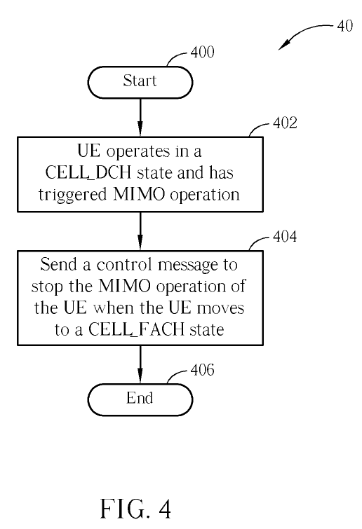

Please refer to FIG. 4, which illustrates a schematic diagram of a process 40 according to an embodiment of the present invention. The process 40 is utilized for enhancing system efficiency in a network of a wireless communications system, and can be compiled into the system efficiency enhancing program code 220. The process 40 comprises the following steps:

Step 400: Start.

Step 402: A UE operates in a CELL_DCH state and has triggered MIMO operation.

Step 404: Send a control message to stop the MIMO operation of the UE when the UE moves to a CELL_FACH state.

Step 406: End.

According to the process 40, when a UE operates in the CELL_DCH state and has triggered MIMO operation, if the UE moves to the CELL_FACH state, the network can send a control message to stop the MIMO operation of the UE. In other words, the network can output the control message to stop the MIMO operation of the UE.

Preferably, in the embodiment of the present invention, the control message is a radio resource control message, a network report message or a reconfiguration message.

In the embodiment of the present invention, since MIMO operation is intended to support UEs in CELL_DCH state, the network can output the control message to stop the MIMO operation when the UE moves from the CELL_DCH state to the CELL_FACH state, so as to prevent system malfunction, and enhance system efficiency.

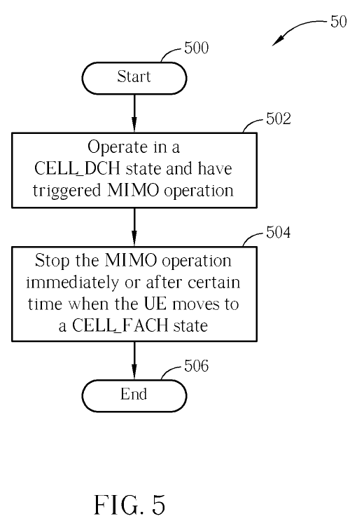

Please refer to FIG. 5, which illustrates a schematic diagram of a process 50 according to an embodiment of the present invention. The process 50 is utilized for enhancing system efficiency in a UE of a wireless communications system, and can be compiled into the system efficiency enhancing program code 220. The process 50 comprises the following steps:

Step 500: Start.

Step 502: Operate in a CELL_DCH state and have triggered MIMO operation.

Step 504: Stop the MIMO operation immediately or after certain time when the UE moves to a CELL_FACH state.

Step 506: End.

According to the process 50, when a UE operates in the CELL_DCH state and has triggered MIMO operation, if the UE moves to the CELL_FACH state, the UE can stop the MIMO operation immediately or after certain time. In other words, the UE can autonomously stop the MIMO operation without commands from the network.

Therefore, comparing the processes 40 and 50, the process 40 is to send a control message from the network to stop the MIMO operation, while the process 50 is to stop the MIMO operation by the UE, and both can prevent system malfunction, and enhance system efficiency.

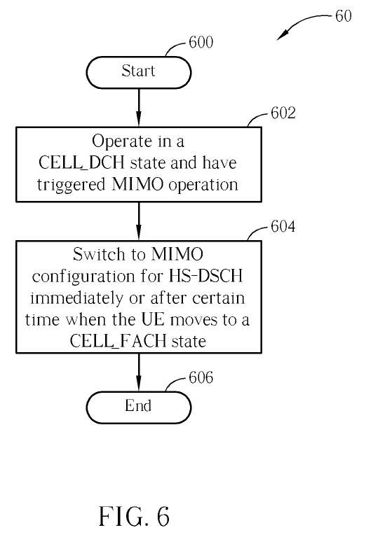

Please refer to FIG. 6, which illustrates a schematic diagram of a process 60 according to an embodiment of the present invention. The process 60 is utilized for enhancing system efficiency in a UE of a wireless communications system, and can be compiled into the system efficiency enhancing program code 220. The process 60 comprises the following steps:

Step 600: Start.

Step 602: Operate in a CELL_DCH state and have triggered MIMO operation.

Step 604: Switch to MIMO configuration for HS-DSCH immediately or after certain time when the UE moves to a CELL_FACH state.

Step 606: End.

According to the process 60, when a UE operates in the CELL_DCH state and has triggered MIMO operation, if the UE moves to a CELL_FACH state, the UE can switch to MIMO configuration for HS-DSCH immediately or after certain time. In other words, even in the CELL_FACH state, the UE can still perform the MIMO operation.

Preferably, in the embodiment of the present invention, the MIMO configuration for HS-DSCH is configured by a network, and the MIMO configuration for HS-DSCH in CELL_FACH state can be the same as or different from the one in CELL_DCH state.

In the prior art, since MIMO operation is intended to support UEs in CELL_DCH state, MIMO is not suitable for UEs in CELL_DCH state moving to CELL_FACH state or UEs originally in CELL_FACH state. In comparison, via the process 60, when a MIMO UE moves from CELL_DCH state to CELL_FACH state, the MIMO UE can still perform MIMO operation.

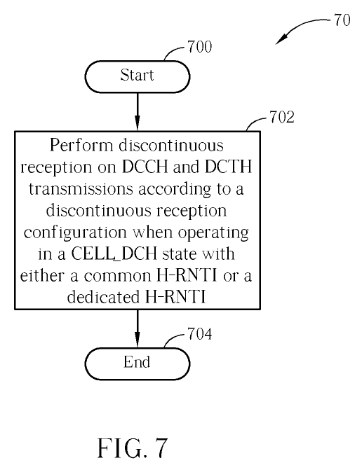

Please refer to FIG. 7, which illustrates a schematic diagram of a process 70 according to an embodiment of the present invention. The process 70 is utilized for enhancing system efficiency in a UE of a wireless communications system, and can be compiled into the system efficiency enhancing program code 220. The process 70 comprises the following steps:

Step 700: Start.

Step 702: Perform discontinuous reception on DCCH and DCTH transmissions according to a discontinuous reception configuration when operating in a CELL_DCH state with either a common H-RNTI or a dedicated H-RNTI.

Step 704: End.

According to the process 70, when the UE operates in the CELL_DCH state with either a common H-RNTI or a dedicated H-RNTI, the UE can perform discontinuous reception on DCCH and DCTH transmissions according to a discontinuous reception configuration. In other words, even in CELL_FACH state, the UE can still perform discontinuous reception on DCCH/DCTH transmissions, so as to reduce power consumption, and enhance system efficiency.

Preferably, the discontinuous reception configuration is configured by a network, and is configured or enabled without the need of having discontinuous transmission configuration to be configured. Moreover, when the UE only has the common H-RNTI, the UE does not autonomously choose the discontinuous reception configuration according to configurations from a network. In opposite, when the UE has the dedicated H-RNTI, the UE autonomously chooses or updates the discontinuous reception configuration according to configurations from a network.

Therefore, via the process 70, when the UE operates in the CELL_DCH state with either a common H-RNTI or a dedicated H-RNTI, the UE can perform discontinuous reception on DCCH and DCTH transmissions according to the discontinuous reception configuration.

In summary, the embodiment of the present invention can improve operations of CELL_FACH state, so as to enhance system efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing system efficiency of a user equipment, called UE hereinafter, in a wireless communications system comprising:
operating in a Cell Forward Link Access Channel, called CELL_FACH hereinafter, state with a common High Speed Downlink Shared Channel radio network transaction identifier, called common H-RNTI hereinafter, and a dedicated H-RNTI; and
providing a confirmation signal with utilizing the dedicated H-RNTI for a network when the network sends transmissions of Dedicated Control Channel, called DCCH hereafter, and Dedicated Traffic Channel, called DTCH hereinafter, with using the common H-RNTI to the UE.

2. A method for enhancing system efficiency of a user equipment, called UE hereinafter, in a wireless communications system comprising:
operating in a Cell Forward Link Access Channel, called CELL_FACH hereinafter, state with a common High Speed Downlink Shared Channel radio network transaction identifier, called common H-RNTI hereinafter, or a dedicated H-RNTI; and
providing a confirmation signal with utilizing a cell RNTI, a network RNTI, or the dedicated H-RNTI for a network when the network sends transmissions of Dedicated Control Channel, called DCCH hereafter, and Dedicated Traffic Channel, called DTCH hereinafter, with using the common H-RNTI or the dedicated H-RNTI to the UE.

3. A method for enhancing system efficiency of a user equipment, called UE hereinafter, in a wireless communications system comprising:
operating in a Cell Forward Link Access Channel, called CELL_FACH hereinafter, state or entering the CELL_FACH state; and
transmitting a measurement result or report to a network when a trigger condition is fulfilled.

4. The method of claim 3, wherein the measurement result or report is a CELL_FACH, or High Speed Downlink Shared Channel, called HS-DSCH hereinafter, measurement, or downlink reference message, or buffer status measurement, or inter-frequency measurement.

5. The method of claim 3, wherein the measurement result or report is sent with complete information required, and if a measurement result or report of the same kind of measurement is triggered with fulfilled condition, the UE considers whether the difference of measurement contents between measurement result sent previously and current measurement result to decided whether to send measurement report.

6. The method of claim 3, wherein the UE transmits the difference between the measurement result sent previously and current measurement result when retransmitting the measurement result or report.

7. The method of claim 3, wherein the UE transmits the measurement result or report through random access procedure, or cell update procedure, or neighboring cell list update, or active cell update procedure.

8. The method of claim 3, wherein the UE or the network is capable of triggering a less operation.

9. The method of claim 8, wherein the less operation can be control channel less operation or operation with reduced or eliminated transmission of control information or operation with pruned-size control information transmission or operation with transmission of shared control information or operation without mandatory accompanying transmission of control information associated with corresponding data transmission.

10. A method for enhancing system efficiency in a network of a wireless communications system comprising:
a user equipment, called UE hereinafter, operating in a Cell Dedicated Channel, called CELL_DCH hereinafter, state and having triggered a Multi-input Multi-output, called MIMO hereinafter, operation; and
sending a control message to stop the MIMO operation of the UE when the UE moves to a Cell Forward Link Access Channel, called CELL_FACH hereinafter, state.

11. The method of claim 10, wherein the control message is a radio resource control message, a network report message or a reconfiguration message.

12. A method for enhancing system efficiency of a user equipment, called UE hereinafter, in a wireless communications system comprising:
operating in a Cell Dedicated Channel, called CELL_DCH hereinafter, state and having triggered a Multi-input Multi-output, called MIMO hereinafter, operation; and
stop the MIMO operation immediately or after certain time when the UE moves to a Cell Forward Link Access Channel, called CELL_FACH hereinafter, state.

13. A method for enhancing system efficiency of a user equipment, called UE hereinafter, in a wireless communications system comprising:
operating in a Cell Dedicated Channel, called CELL_DCH hereinafter, state and having triggered a Multi-input Multi-output, called MIMO hereinafter, operation; and
switching to MIMO configuration for a High Speed Downlink Shared Channel, called HS-DSCH hereinafter, immediately or after certain time when the UE moves to a Cell Forward Link Access Channel, called CELL_FACH hereinafter, state.

14. The method of claim 13, wherein the MIMO configuration for HS-DSCH is configured by a network.

15. The method of claim 13, wherein the MIMO configuration for HS-DSCH in CELL_FACH state is the same as the one in CELL_DCH state.

16. The method of claim 13, wherein the MIMO configuration for HS-DSCH in CELL_FACH state is different from the one in CELL_DCH state.

17. A method for enhancing system efficiency of a user equipment, called UE hereinafter, in a wireless communications system comprising:
performing discontinuous reception on transmissions of Dedicated Control Channel, called DCCH hereafter, and Dedicated Traffic Channel, called DTCH hereinafter according to a discontinuous reception configuration when operating in a Cell Dedicated Channel, called CELL_DCH hereinafter, state with either a common High Speed Downlink Shared Channel radio network transaction identifier, called common H-RNTI hereinafter, or a dedicated H-RNTI.

18. The method of claim 17, wherein the discontinuous reception configuration is configured by a network.

19. The method of claim 17, wherein the UE does not autonomously choose the discontinuous reception configuration according to configurations from a network when the UE only has the common H-RNTI.

20. The method of claim 17, wherein the UE autonomously chooses or updates the discontinuous reception configuration according to configurations from a network when the UE has the dedicated H-RNTI.

21. The method of claim 17, wherein the discontinuous reception configuration is configured or enabled without the need of having discontinuous transmission configuration to be configured.

22. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
operating in a Cell Forward Link Access Channel, called CELL_FACH hereinafter, state with a common High Speed Downlink Shared Channel radio network transaction identifier, called common H-RNTI hereinafter, and a dedicated H-RNTI; and
providing a confirmation signal with utilizing the dedicated H-RNTI for a network when the network sends transmissions of Dedicated Control Channel, called DCCH hereafter, and Dedicated Traffic Channel, called DTCH hereinafter, with using the common H-RNTI to the communications device.

23. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
operating in a Cell Forward Link Access Channel, called CELL_FACH hereinafter, state with a common High Speed Downlink Shared Channel radio network transaction identifier, called common H-RNTI hereinafter, or a dedicated H-RNTI; and
providing a confirmation signal with utilizing a cell RNTI, a network RNTI, or the dedicated H-RNTI for a network when the network sends transmissions of Dedicated Control Channel, called DCCH hereafter, and Dedicated Traffic Channel, called DTCH hereinafter, with using the common H-RNTI or the dedicated H-RNTI to the communications device.

24. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
operating in a Cell Forward Link Access Channel, called CELL_FACH hereinafter, state or entering the CELL_FACH state; and
transmitting a measurement result or report to a network when a trigger condition is fulfilled.

25. The communications device of claim 24, wherein the measurement result or report is a CELL_FACH, or High Speed Downlink Shared Channel, called HS-DSCH hereinafter, measurement, or downlink reference message, or buffer status measurement, or inter-frequency measurement.

26. The communications device of claim 24, wherein the measurement result or report is sent with complete information required, and if a measurement result or report of the same kind of measurement is triggered with fulfilled condition, the UE considers whether the difference of measurement contents between measurement result sent previously and current measurement result to decided whether to send measurement report.

27. The communications device of claim 24, wherein the UE transmits the difference between the measurement result sent previously and current measurement result when retransmitting the measurement result or report.

28. The communications device of claim 24, wherein the UE transmits the measurement result or report through random access procedure, or cell update procedure, or neighboring cell list update, or active cell update procedure.

29. The communications device of claim 24, wherein the UE or the network is capable of triggering a less operation.

30. The communications device of claim 29, wherein the less operation can be control channel less operation or operation with reduced or eliminated transmission of control information or operation with pruned-size control information transmission or operation with transmission of shared control information or operation without mandatory accompanying transmission of control information associated with corresponding data transmission.

31. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
a user equipment, called UE hereinafter, operating in a Cell Dedicated Channel, called CELL_DCH hereinafter, state and having triggered a Multi-input Multi-output, called MIMO hereinafter, operation; and
sending a control message to stop the MIMO operation of the UE when the UE moves to a Cell Forward Link Access Channel, called CELL_FACH hereinafter, state.

32. The communications device of claim 31, wherein the control message is a radio resource control message, a network report message or a reconfiguration message.

33. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
operating in a Cell Dedicated Channel, called CELL_DCH hereinafter, state and having triggered a Multi-input Multi-output, called MIMO hereinafter, operation; and
stop the MIMO operation immediately or after certain time when the UE moves to a Cell Forward Link Access Channel, called CELL_FACH hereinafter, state.

34. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
operating in a Cell Dedicated Channel, called CELL_DCH hereinafter, state and having triggered a Multi-input Multi-output, called MIMO hereinafter, operation; and
switching to MIMO configuration for a High Speed Downlink Shared Channel, called HS-DSCH hereinafter, immediately or after certain time when the UE moves to a Cell Forward Link Access Channel, called CELL_FACH hereinafter, state.

35. The communications device of claim 34, wherein the MIMO configuration for HS-DSCH is configured by a network.

36. The communications device of claim 34, wherein the MIMO configuration for HS-DSCH in CELL_FACH state is the same as the one in CELL_DCH state.

37. The communications device of claim 34, wherein the MIMO configuration for HS-DSCH in CELL_FACH state is different from the one in CELL_DCH state.

38. A communications device of a wireless communications system utilized for enhancing system efficiency comprising:
a control circuit for realizing functions of the communications device;
a processor installed in the control circuit for executing a program code to operate the control circuit; and
a memory coupled to the processor for storing the program code;
wherein the program code comprises:
performing discontinuous reception on transmissions of Dedicated Control Channel, called DCCH hereafter, and Dedicated Traffic Channel, called DTCH hereinafter according to a discontinuous reception configuration when operating in a Cell Dedicated Channel, called CELL_DCH hereinafter, state with either a common High Speed Downlink Shared Channel radio network transaction identifier, called common H-RNTI hereinafter, or a dedicated H-RNTI.

39. The communications device of claim 38, wherein the discontinuous reception configuration is configured by a network.

40. The communications device of claim 38, wherein the UE does not autonomously choose the discontinuous reception configuration according to configurations from a network when the UE only has the common H-RNTI.

41. The communications device of claim 38, wherein the UE autonomously chooses or updates the discontinuous reception configuration according to configurations from a network when the UE has the dedicated H-RNTI.

42. The communications device of claim 38, wherein the discontinuous reception configuration is configured or enabled without the need of having discontinuous transmission configuration to be configured.
